(19) United States
(12) Patent Application Publication
(10) Pub. No.: US 2006/0093989 A1
(43) Pub. Date: May 4, 2006

(54) Dental therapeutic device

(75) Inventors: Rainer Hahn, Tuebingen (DE); Ulrich Prager, Abstatt (DE)

Correspondence Address: FACTOR & LAKE, LTD, 1327 W. WASHINGTON BLVD., SUITE 5G/H, CHICAGO, IL, 60607, US

(73) Assignee: Durr Dental GmbH & Co. KG, D-74321 Bietigheim-Bissingen (DE)

(21) Appl. No.: 10/505,473

(22) PCT Filed: Jan. 23, 2003
(86) PCT No.: PCT/EP03/00662

§ 371 Date: Dec. 12, 2005

(30) Foreign Application Priority Data
Jan. 23, 2002 (DE) 102 02 378.6

(51) Int. Cl. A61C 17/02

(52) U.S. Cl. 433/80

(57) ABSTRACT

Disclosed is a dental therapeutic device used for infiltrating and/or rinsing tissue or hollow spaces bordered by tissue, particularly tooth tissue or hollow spaces bordered by tooth tissue, with a therapeutic fluid. The inventive device comprises a storage container (2) for the therapeutic fluid, a hollow needle (42) for feeding the therapeutic fluid into the tissue, a pump (15, 43, 47) feeding the therapeutic fluid from the storage container (2) to the hollow needle (42), and a pump (15, 43, 47) sucking therapeutic fluid from the tissue via the hollow needle (42). All of said components are comprised in a hand-piece-type unit, whereby a very compact dental therapeutic device is created which is easy to handle for the dentist and requires no external units or only units that are generally part of a dentist's practice.

The invention relates to a dental therapeutic instrument for infiltrating and/or rinsing tissue or cavities bounded by tissue, in particular dental tissue or cavities bounded by dental tissue, with a therapeutic liquid, said instrument having
a) a storage container for the therapeutic liquid;
b) a cannula for introducing the therapeutic liquid into the tissue or into the cavities;
c) a pump which supplies the therapeutic liquid to the cannula from the storage container;
d) a pump which withdraws therapeutic liquid from the tissue by suction via the cannula.

A therapeutic instrument of such a type is known from DE 197 14 167 A1, in particular from FIG. 4 therein. In this printed publication it is also specified in detail which therapeutic liquids enter into consideration and which purpose is associated with the infiltration and/or rinsing of the tissue. Reference may be made hereto.

In the case of the therapeutic liquid described in DE 197 14 167 A1 a handpiece is employed that substantially comprises only the cannula and certain sensors and control elements which are required there for the reason that this therapeutic instrument is also intended to be employed as a diagnostic instrument. The pumps and storage containers and also the other assemblies required for operation are kept outside the handpiece and are connected to the latter via a supply cable. In this manner the entire therapeutic instrument takes up a relatively large amount of space in the dental surgery and requires a comparatively high investment outlay, since no use is made of assemblies that are already present in the dental surgery.

The object of the present invention is to configure a therapeutic instrument of the type specified in the introduction in such a way that it is easy to handle and inexpensive and also needs little space.

This object is achieved, according to the invention, by the storage container, the cannula and the pumps being combined into a handpiece-type unit.

According to the invention the therapeutic instrument is accordingly constituted by a unit which can be handled in the same manner as other handpieces that are customary in a dental surgery but which combines all the requisite components in itself and, if need be, has recourse to assemblies that are normally to be found in a dental surgery. In this manner the costs and the space requirement are considerably reduced in comparison with the state of the art.

In this connection it is particularly expedient if the pump that supplies therapeutic liquid to the cannula and the pump that withdraws the therapeutic liquid by suction via the cannula are implemented by a single pump, the working direction of which is reversible. This combination of both pump functions in a single pump reduces the space requirement that is necessary for the pumps, which is particularly important in connection with the integration, according to the invention, into a handpiece. This combination of the two pump functions becomes possible for the reason that in the case of the therapeutic instrument according to the invention only one of the two pump functions is needed at all times, so that an alternating operation of the single pump with changing working direction is possible.

In this connection, that embodiment of the invention has proved to be favourable in particular in which the single pump comprises a double-acting, linearly mobile piston which with one end region adjoins a first working space which is connected to the reservoir via a check valve and with the opposite end region adjoins a second working space which communicates with the cannula, the first working space communicating with the second working space via a flow path in which a check valve is situated which permits a flow of the therapeutic liquid only from the first working space into the second working space. If this double-acting piston moves in one direction, then on the one hand therapeutic liquid is aspirated out of the storage container into the first working space and on the other hand therapeutic liquid is expelled out of the second working space in the direction towards the cannula. In the case of movement of the piston running in the opposite direction, the therapeutic liquid located in the first working space is displaced into the second working space, into which, in addition, liquid is aspirated out of the tissue or the cavity via the cannula. Said liquid is a mixture of tissue fluid, saliva, debris and therapeutic liquid. This style of construction makes do with unusually few structural components for the functions that are striven for, which in turn works to the advantage of the space requirement and the costs.

The flow path leading from the first working space to the second working space may be a bore which is directed axially through the piston, once again reducing the space requirement.

In general, the therapeutic liquid injected into the tissue is not fully aspirated back, by reason of losses due to leakage; rather, the therapeutic liquid that is employed for the purpose of rinsing and/or infiltrating is constantly supplemented from the reservoir. A rinsing action is achieved by this means, since the greatest amount of debris is flushed out with the excess therapeutic liquid before the main volume of the liquid is aspirated back. To this end, a configuration of the invention is advisable in which the cross-section of the end region of the piston adjoining the first working space is smaller than the cross-section of the end region of the piston adjoining the second working space. By reason of the smaller cross-section of the first end region, in the course of each piston stroke in the appropriate direction less therapeutic liquid is taken out of the storage container than is simultaneously expelled from the second working space in the direction towards the cannula. In the course of the reverse stroke of the piston, the volume of the liquid aspirated back is then supplemented by that volume which was previously aspirated out of the storage container into the first working space.

The mode of operation of the therapeutic instrument, in which, at regular intervals, the therapeutic liquid is both injected into the tissue or into the adjoining cavities and also withdrawn again from the tissue or the cavities by suction, is particularly suitable for thorough infiltration. The synchronised movement permits a very effective rinsing by virtue of intensive interchange between tissue fluid and therapeutic liquid. In particular, the active substances of the therapeutic liquid are conveyed well into deep tissue segments, and debris, including bacteria, are detached well from boundary surfaces. A fraction of the debris is expelled with the leakage; another fraction of the tissue fluid is aspirated back, mixed with therapeutic liquid and conveyed in again. As a result, a good cleaning is achieved by virtue of the leakage.

Before the synchronised movement is initiated, however, a pure rinsing should firstly take place for a short time, by which most of the debris is expelled.

In many cases, however, a pure rinsing of the tissue is also desirable in which exclusively fresh therapeutic liquid is introduced into the tissue and no therapeutic liquid is aspirated back. Suitable for this purpose is that embodiment of the invention in which a control valve is provided which in a first position connects the second working space to the cannula via a flow path that is capable of being flowed through in both directions and in a second position connects the second working space to the cannula and to a further flow path leading to the reservoir via a flow path that is capable of being flowed through only in the direction towards the cannula, a check valve which exclusively permits a flow in the direction towards the second working space being situated in the further flow path. In this rinsing mode of operation, that volume of therapeutic liquid which is aspirated back out of the tissue in the first operating mode is accordingly replaced by fresh therapeutic liquid originating from the storage container.

The control valve may comprise a slide that is capable of being displaced linearly in a bore.

Furthermore it is expedient if the double-acting piston is driven by an actuating piston which is acted upon on one side by a compression spring and which on the opposite side adjoins a pressure chamber which in turn communicates with the outlet of a compressed-air pulse generator. Accordingly, only one source of compressed air, such as is available in any case in all dental surgeries, is required for operating this therapeutic instrument. A separate procurement is this regard is not necessary. The compressed-air pulse generator, which in accordance with its name generates pulses of compressed air at a certain repetition frequency, is accordingly of a type such as is commercially available.

In this context it is furthermore expedient if the inlet of the compressed-air pulse generator is capable of being connected to a compressed-air supply cable for conventional dental handpieces via a standard coupling. The dentist is accordingly able simply to couple the therapeutic instrument according to the invention that has been configured in accordance with this embodiment to the same supply hose via which he/she also operates his/her other handpieces.

The reservoir may be a detachably arranged syringe which exhibits a smooth-running syringe piston. The ease of running of the syringe piston is necessary for the reason that it moves exclusively under the influence of the vacuum generated by the pump, which empties the syringe. Accordingly, no external pressure is exerted on the syringe piston for the purpose of emptying the syringe.

The syringe may be a re-usable syringe made of autoclavable material, but it may alternatively be a disposable syringe. In the latter case it is not necessary for the disposable syringe to have a piston rod, since this syringe is, after all, only emptied, and this is effected under the influence of the aspirating pump.

An alternative exemplary embodiment of the therapeutic instrument according to the invention is distinguished by the fact that the storage container is a syringe with a syringe body and a syringe piston, which is connected to a linearly mobile output member of a reversible drive device for the syringe piston. In this case the syringe combines in itself both the function of the storage container and—when driven by the drive device—the function of the pump. In the course of the outward movement of the syringe piston, therapeutic liquid is aspirated back out of the tissue, whereas therapeutic liquid is expressed into the tissue in the course of the inward movement of the syringe piston.

The drive device may exhibit a electric motor and a battery energising said motor. In this case the handpiece-type unit, in the form of which the therapeutic instrument is configured, is completely independent of external assemblies, so it does not even need a connection to a source of compressed air.

The drive device should in this case exhibit control electronics that are programmed in such a way that the syringe piston is capable of being moved back and forth at a certain repetition frequency. Accordingly, the dentist only needs to hold the therapeutic instrument; the controlled drive device undertakes the requisite movement of the syringe piston back and forth.

Once again it is advisable in this connection if the control electronics are programmed in such a way that the syringe piston executes a larger stroke in the course of the inward movement than in the course of the outward movement. This is again connected with the fact that less therapeutic liquid can be aspirated back out of the tissue than was previously injected.

If this type of therapeutic instrument is also intended to be employed for rinsing, the control electronics can be operated in a second operating mode in which the syringe piston exclusively executes an inward movement.

Exemplary embodiments of the invention will be elucidated in more detail in the following on the basis of the drawing; shown are:

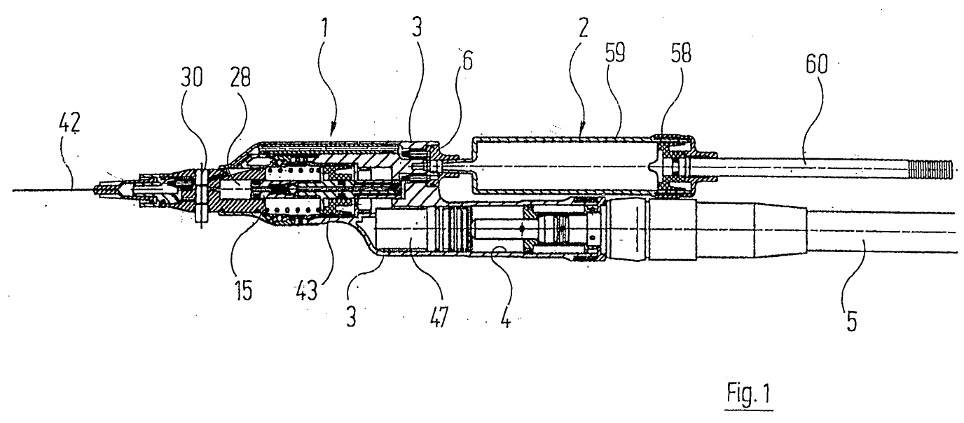

FIG. 1: a section through a first exemplary embodiment of a dental therapeutic instrument;

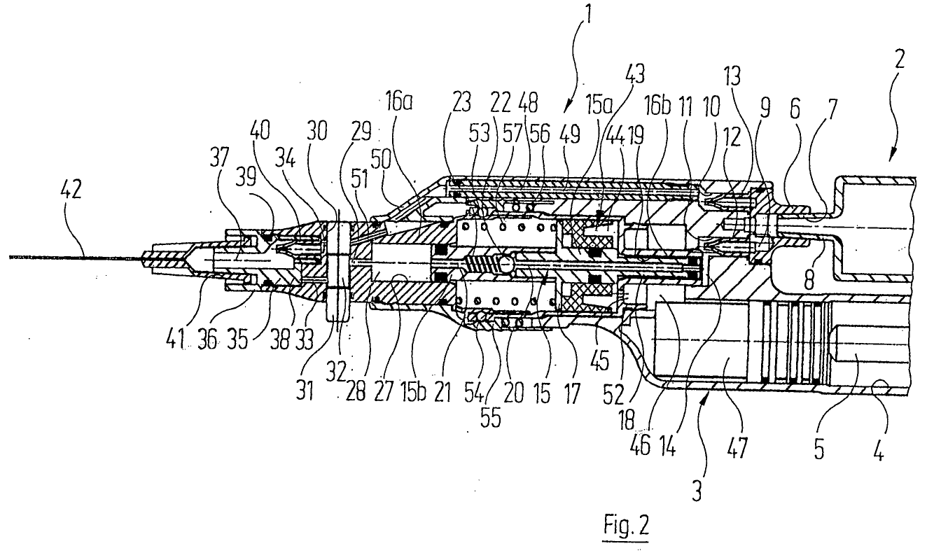

FIG. 2: a selective enlargement from FIG. 1;

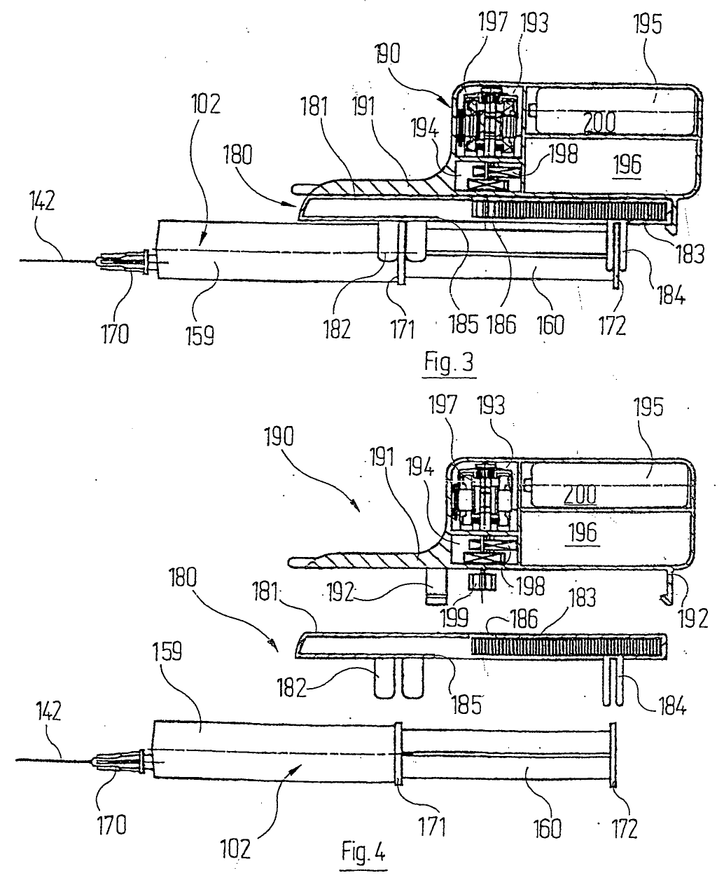

FIG. 3: a section through another exemplary embodiment of a dental therapeutic instrument;

FIG. 4: an exploded view of the main components of the dental therapeutic instrument of FIG. 3.

Reference will firstly be made to FIGS. 1 and 2, in which a dental therapeutic instrument is represented which is operated with compressed air and which can be connected to the compressed-air port of a conventional dental handpiece. This dental therapeutic instrument is consequently self-sufficient in the sense that it requires no external pumps or other devices, with the exception of the compressed-air port which is present in any case in a dental surgery, and is capable of being actuated with the aid of the foot switch that is used by the dentist for the conventional handpieces.

The therapeutic instrument comprises as main component a handpiece 1, to which a syringe 2 is detachably fitted which is conventional except for the following differences.

As is shown in particular by FIG. 2, the handpiece 1 exhibits a casing 3 which on the right-hand side in FIG. 2 possesses a connecting bore 4 for the conventional compressed-air supply hose 5.

Above the connecting bore 4 a connecting piece 6, which exhibits a central insertion opening 7 for the neck 8 of the syringe 2, is inserted into the casing 3. The insertion opening 7 and the connecting bore 4 are substantially axially parallel.

The insertion opening 7 of the connecting piece 6 communicates via spaces 9, only one of which is visible in the drawing, with two axially parallel inlet ducts 10, 11, in each of which a check valve 12, 13 is arranged. The check valves 12, 13 are fabricated from elastic hose material which at the left-hand end—that is to say, the interior end—in the drawing is pressed flat in such a way that a flow from right to left in the drawing is possible, but on the other hand a flow in the opposite direction is prohibited.

The inlet duct 11 which is situated at the bottom in FIGS. 1 and 2 communicates with a first working space 14 which is bounded between a linearly displaceable, double-acting piston 15, the casing 3 and an insert 16 which is detachably assembled from two parts.

The piston 15 is also assembled from two parts 15a, 15b. The right-hand piston part 15a in FIG. 2 exhibits a radially projecting flange 17 and also a region 18 which is reduced in diameter and which slides tightly in a bore 19 of the right-hand insert part 16b in FIGS. 1 and 2. The entire right-hand piston part 15a is penetrated by an axial bore 20 from its right-hand end face as far as the left-hand end face.

The bore 20 of the right-hand piston part 15a continues in an axial stepped bore 21 of the left-hand piston part 15b in FIGS. 1 and 2. In this stepped bore 21 a check valve 22 is arranged which takes the form of a ball valve, the ball of this check valve 22 being pressed against a valve seat by a spring 23. The arrangement is accordingly such that the check valve 22 permits a flow through the bore 21 of the piston 15 from right to left in FIGS. 1 and 2 but not in the opposite direction.

The left-hand end region of the piston 15 is sunk into a bore 24 of the left-hand insert part 16a and bounds with the latter a second working space 28. The second working space 28 is in communication via a thin axial bore 29 with a transverse bore 30 which is directed through the entire insert part 16a and in which a linearly guided slide 31 is arranged in diplaceable manner. The slide 31 possesses a central region 32 which is reduced in diameter, so that at the place where this central region 32 is located, between the transverse bore 30 and the slide 31, an annular gap is present which can be flowed through.

From the transverse bore 30 two narrow, axially parallel ducts 33, 34 branch off which lead into an intake opening 35 on the left-hand end face of the left-hand insert part 16a.

Inserted into the intake opening 35 is a coupling piece 36 which possesses a central, axial bore 37 opening on the left in FIGS. 1 and 2. The bore 37 of the coupling piece 36 communicates with the lower duct 33 via an obliquely directed bore 38 and with the duct 34 in the left-hand insert part 16a via a larger bore 39 directed axially parallel. Arranged in the bore 39 is a check valve 40 which is constructed in the same manner as the check valves 12 and 13 already discussed above and is orientated in such a way that a flow out of the bore 30 in the left-hand insert part 16a into the bore 37 in the coupling piece 36 is possible, but not in the opposite direction.

On its left-hand end face in FIGS. 1 and 2 the coupling piece 36 is provided with the male connecting components of a Luer connection, which are introduced into the complementary female connecting components 41 of a cannula 42.

In the interspace between the circumferential surface of the right-hand piston part 15a and the internal circumferential surface of the right-hand insert part 16b an actuating piston 43 fabricated from elastic material is displaceably guided which with one side abuts a ring surface of the flange 17 of the double-acting piston 15. A pressure chamber 44 situated on the right of the actuating piston 43 in FIGS. 1 and 2 is in communication, by virtue of bores 45 extending axially parallel, with a space 46 situated between the right-hand insert part 16b and the casing 3. Said space communicates in turn with the outlet of a commercial compressed-air pulse generator 47 which is arranged at the inner end of the inlet bore 4 of the casing 3 and is capable of generating a sequence, which for example has a repetition frequency of 2 Hz, of compressed-air pulses from the compressed air which is supplied via the compressed-air line 4.

The upper (10) of the two inlet ducts 10, 11 which are adjacent to the syringe 2 continues in a throttle part 48 which has been inserted into this duct 10 and which is penetrated over its entire length by a bore 49. The left-hand end face of the throttle part 49 communicates with the transverse bore 30 via a duct 50 in the casing 3 and via a duct 51 in the left-hand insert part 16a, the point of entry of the duct 51 into the transverse bore 30 having a lateral spacing from the point of entry of the bore 29 which leads to the second working space 28.

The right-hand insert part 16b is locked to the inner wall of the casing 3 with the aid of an apron 52 which exhibits detent lugs.

The two insert parts 16a, 16b are fastened to one another by a releasable quick coupling. This quick coupling comprises three balls 53 situated in bores on the external circumferential surface of the right-hand end region of the left-hand insert part 16a, which pass through openings in the left-hand end region of the right-hand insert part 16b and with their radially exterior side interact with the inner circumferential surface of an annular slide valve 55. The annular slide valve 55 is normally pushed by a compression spring 56, which is clamped between it and a step of the casing 3, into the position represented in the drawing, in which its internal circumferential surface pushes the balls 53 radially inwards into the openings in the left-hand insert part 16a. With the aid of a finger, the annular slide valve 55 can be moved to the right in FIGS. 1 and 2 contrary to the action of the compression spring 56 until the balls 53 come free from the annular slide valve 55. The left-hand insert part 16a can then be easily taken out in the axial direction.

The therapeutic instrument described above can operate in two operating modes:

In the first operating mode the slide 31 is positioned as represented in FIGS. 1 and 2. In this operating mode said slide enables a flow connection between the bore 29 of the left-hand casing part 16a, which leads to the second working space 28, and the lower duct 33, hence ultimately to the cannula 42.

If the source of compressed air is now switched on with the aid of the foot switch, the compressed-air pulse generator 47 generates pulses of compressed air at the repetition frequency already mentioned above of approximately 0.5 Hz to 2 Hz. With each of these pulses the following happens:

The compressed air, which gets into the pressure chamber 44 bordering the actuating piston via the space 46 and the bores 45 in the right-hand insert part 16b, slides the actuating piston 43 to the left in FIGS. 1 and 2 contrary to the action of the compression spring 57, whereby by reason of the abutment on the annular flange 17 of the piston 15 it also entrains the latter. In the course of this stroke the left-hand end of the piston 15a in FIGS. 1 and 2 penetrates more deeply into the bore 27 of the left-hand insert part 16a and in this manner displaces the liquid located in the second working space 28 via the bore 29, the annular space between the slide 31 and the transverse bore 30, the duct 33 which is not provided with a check valve, and the bore 38 into the bore 37 of the coupling piece 35 and from there into the cannula 42. In this connection the dimensions of the working space 28 and the stroke of the piston 15 are matched to one another in such a way that an ejection volume of approximately 0.3 ml arises.

In the course of this stroke of the piston 15, in addition the right-hand end region 18 of the piston 15, which is reduced in diameter, moves to the left, the first working space 14 thereby being enlarged. As a result, a certain volume of the therapeutic liquid held in store in the syringe is aspirated out of the syringe 2 via the check valve 12. By reason of the smaller diameter of the piston region 18, the aspirated volume of liquid is smaller than that which is simultaneously expelled from the second working space 28, in the example 0.1 ml.

As soon as the pulse of compressed air generated by the compressed-air pulse generator 47 falls off, the piston 15 and the actuating piston 43 are again traversed to the right by the compression spring 57 into the position represented in FIGS. 1 and 2, the pressure chamber 44 situated to the right of the actuating piston 43 being de-aerated with the aid of the compressed-air pulse generator 47. In the course of the stroke of the piston 15 directed to the right, the following happens:

The left-hand end region 15b of the piston 15 moves in such a way that the second working space 28 is enlarged and liquid is aspirated back into this working space 28 via the cannula 42 and also via the flow connection described in detail above. However, by reason of losses due to leakage, in this case the full, previously ejected volume of the liquid is no longer aspirated back; rather, only a reduced volume of liquid of, for example, 0.2 ml can be recovered via the cannula 42. During the stroke of the piston 15 directed towards the right, however, the volume of liquid located in the first working space 14 is displaced out of this working space 14 into the second working space 28 via the bores 20, 21 of the piston 15, whereby the check valve 22 opens. The check valve 12 located in the inlet duct 11 remains closed during this time. In the second working space 28 there is now again a quantity of liquid amounting to a total of approximately 0.3 ml, 0.2 ml of which is aspirated back via the cannula 42, and 0.1 ml of which was taken from the syringe.

In this manner the volume of the stock of liquid in the syringe 2 diminishes continuously; at the same time, the syringe piston 58 (see FIG. 1) moves inwards in the syringe body 59 without a force needing to be exerted on the piston rod 60. This presupposes, however, that the syringe piston 58 moves within the syringe body 59 in as frictionless a manner as possible. Therefore polytetrafluoroethylene is preferably employed as material for the syringe piston 58.

If disposable syringes are employed, a piston rod 60 is not required, since the syringe piston 58 serves only for sealing the inner space of the syringe body 59, which changes in volume. A piston rod 60 is only needed in the case of re-usable syringes 2 for the purpose of refilling the syringe body 59.

The therapeutic instrument that has been described can be utilised in a second operating mode which serves for rinsing without reverse suction of therapeutic liquid taking place via the cannula 42. To this end, the slide 31 is displaced in the transverse bore 30 of the left-hand casing insert 16 in such a way that it creates a connection between the bore 29, the duct 51 and the duct 34 of the left-hand insert part 16a. If the source of compressed air is switched on in this position of the slide 31, the following happens:

In the course of each stroke of the piston 15 directed to the left, the entire contents, amounting to approximately 0.3 ml, of the second working space 28 are expelled, as previously described, and conveyed to the cannula 42 via the duct 34 and also the check valve 40. In the course of the stroke of the piston 15 proceeding in the opposite direction, however, a reverse suction of liquid out of the cannula 42 is not possible, on account of the closing check valve 40. In the same manner as in the first mode of operation, the volume of liquid previously aspirated out of the syringe 2 is in fact displaced into the second working space 28; the residual amount of therapeutic liquid required for complete filling of the second working space 28, in the example 0.2 ml, is likewise aspirated out of the syringe 2 via the bore 51 of the left-hand insert part 16a, the bore 50 of the casing 3, the bore 49 of the throttle part 48, and the check valve 13. This means that at all times only fresh liquid emerges via the cannula 42, with which rinsing can be brought about.

The second exemplary embodiment of a dental therapeutic instrument represented in FIGS. 3 and 4 operates without any external supply of energy—that is to say, it is fully self-sufficient. It comprises a substantially commercial syringe 102, the body 159 of which is connected to the cannula 142 at the left-hand end in FIGS. 3 and 4 via a Luer coupling 170. A radially projecting collar 171 is moulded on the right-hand, open end of the syringe body 159. In corresponding manner a radially projecting collar 172 is moulded onto the outer end of the piston rod 160.

The syringe 102 is held by an actuating part 180. The casing 181 of said actuating part exhibits a fastening fork 182 which can be slid in positive manner over the collar 171 of the syringe body 159. Within the casing 181 a rack 183 is arranged in linearly displaceable manner. The latter is connected to a further fastening fork 184 which extends through an opening 185 in the casing 181 and can be slid in positive manner over the collar 172 of the syringe piston 160. In the middle of the side of the casing 181 situated at the top in FIGS. 3 and 4 a further opening 186 is provided, the point of which will become clear further below.

A motor part 190 likewise exhibits a casing 191 which can be detachably fastened to the actuating part 180 with the aid of detent lugs 192.

The interior space of the casing 191 is subdivided into four compartments 193, 194, 195 and 196. In compartment 193 a reversible electric motor 197 is located, the direction of rotation of which can accordingly be reversed. The output shaft of the electric motor 197 projects into compartment 194 and is connected therein to a gear mechanism 198 which is represented schematically. The driven shaft of the gear mechanism 198 is realised by the underside of the casing 191 of the motor part 190 and bears a pinion 199. In compartment 195 a battery 200 is accommodated which serves for energising the electric motor 197 and for energising control electronics which are provided in compartment 196 and which are not represented.

For the purpose of operating the therapeutic instrument, the syringe 102, the actuating part 180 and the motor part 190 are assembled in the manner represented in FIG. 3. In this connection the pinion 199 passes through the opening 186 on the upper side of the actuating part 180 and comes into engagement with the rack 183.

The second exemplary embodiment of a dental therapeutic instrument represented in FIGS. 3 and 4 can also be utilised in two operating modes. To this end, two different stored programs can be retrieved from the control electronics accommodated in compartment 196:

In the first operating mode the electric motor 197 is operated successively in different directions of rotation in such a way that the rack 183 is guided within the casing 181 in a type of pilger. This means that the syringe piston 160 which is connected to the fastening fork 184 of the rack 183 is pushed so far into the syringe body 159 that a certain amount of the therapeutic liquid located therein, for example 0.3 ml, is emitted via the cannula 142. By the direction of rotation of the electric motor 197 being reversed, the syringe piston 160 is then pulled back again by a certain distance which corresponds to the volume of the liquid to be aspirated back—that is to say, for example, 0.2 ml. After renewed change-over of the direction of rotation of the electric motor 197, the syringe piston 160 is again pushed in the direction of the cannula 142, again to the extent that corresponds to the volume of liquid to be emitted, in the example 0.3 ml. This process is repeated until such time as either the user switches off the electric motor 197 or the syringe 102 has been emptied.

In the rinsing mode the electric motor 197 is driven by the control electronics in such a way that it moves exclusively in one direction of rotation. In this operating mode the syringe piston 160 is pushed steadily into the syringe body 159, continuously or in individual steps, so that liquid from the syringe body 159 emerges exclusively via the cannula 142 and no reverse suction takes place.

Instead of a pinion 199, on the driven shaft of the gear mechanism 198 use may also be made of a nut which co-operates with a threaded spindle which is employed instead of the rack 183.

1. A dental therapeutic instrument for infiltrating and/or rinsing tissue or cavities bounded by tissue, in particular dental tissue or cavities bounded by dental tissue, with a therapeutic liquid, said instrument having
a) a storage container for the therapeutic liquid;
b) a cannula for introducing the therapeutic liquid into the tissue or into the cavities;
c) a pump which supplies the therapeutic liquid to the cannula from the storage container;
d) a pump which withdraws therapeutic liquid from the tissue by suction via the cannula,
characterised in that
the storage container (2; 102), the cannula (42; 142) and the pumps (15, 43, 47; 160, 180, 191) are combined into a handpiece-type unit.

2. Therapeutic instrument according to claim 1, characterised in that the pump that supplies the therapeutic liquid to the cannula (42; 142) and the pump that aspirates the therapeutic liquid via the cannula (42; 142) are implemented by a single pump (15, 43, 47; 160, 180, 191), the working direction of which is reversible.

3. Therapeutic instrument according to claim 2, characterised in that the single pump comprises a double-acting, linearly mobile piston (15) which with one end region (18) borders a first working space (14) which is connected to the reservoir via a check valve (12) and with the opposite end region (15b) borders a second working space (28) which communicates with the cannula (42), the first working space (14) communicating with the second working space (28) via a flow path (20, 21) in which a check valve (22) is situated which permits a flow of the therapeutic liquid only from the first working space (14) into the second working space (28).

4. Therapeutic instrument according to claim 3, characterised in that the flow path leading from the first working space (14) to the second working space (28) is a bore (20, 21) which is directed axially through the piston (15).

5. Therapeutic instrument according to claim 3 or 4, characterised in that the cross-section of the end region (18) of the piston (15) adjoining the first working space (14) is smaller than the cross-section of the end region (15b) of the piston (15) adjoining the second working space (28).

6. Therapeutic instrument according to one of claims 2 to 5, characterised in that a control valve (31) is provided which in a first position connects the second working space (28) to the cannula via a flow path (33, 37) that is capable of being flowed through in both directions and in a second position connects the second working space (28) to the cannula (42) and to a further flow path (10, 49, 50, 51) leading to the reservoir (2) via a flow path (34, 39, 40) that is capable of being flowed through only in the direction towards the cannula (42), a check valve (13) which exclusively permits a flow in the direction towards the second working space (28) being situated in the further flow path (10, 49, 50).

7. Therapeutic instrument according to claim 6, characterised in that the control valve comprises a slide (31) which is capable of being displaced linearly in a bore (30).

8. Therapeutic instrument according to one of claims 3 to 7, characterised in that the double-acting piston (15) is driven by an actuating piston (43) which is acted upon on one side by a compression spring (57) and which on the opposite side adjoins a pressure chamber (44) which in turn communicates with the outlet of a compressed-air pulse generator (47).

9. Therapeutic instrument according to claim 8, characterised in that the inlet of the compressed-air pulse generator (47) is capable of being connected to a compressed-air supply cable (5) for conventional dental handpieces via a standard coupling.

10. Therapeutic instrument according to one of claims 3 to 5, characterised in that the reservoir (2) is a detachably fitted syringe which exhibits a smooth-running syringe piston (58).

11. Therapeutic instrument according to claim 10, characterised in that the syringe (2) is a re-usable syringe consisting of autoclavable material.

12. Therapeutic instrument according to claim 10, characterised in that the syringe (2) is a disposable syringe.

13. Therapeutic instrument according to claim 12, characterised in that the disposable syringe (2) has no piston rod.

14. Therapeutic instrument according to claim 1 or 2, characterised in that the storage container is constituted by a syringe (102) with a syringe body (159) and a syringe piston (160), which is connected to a linearly mobile output member (184) of a reversible drive device (180, 190) for the syringe piston (160).

15. Therapeutic instrument according to claim 14, characterised in that the drive device (180, 190) exhibits an electric motor (197) and a battery (200) energising said motor.

16. Therapeutic instrument according to claim 14 or 15, characterised in that the drive device (180, 190) exhibits control electronics which are programmed in such a way that the syringe piston (160) is capable of being moved back and forth at a certain repetition frequency.

17. Therapeutic instrument according to claim 16, characterised in that the control electronics are programmed in such a way that the syringe piston (160) executes a larger stroke in the course of the inward movement than in the course of the outward movement.

18. Therapeutic instrument according to claim 16 or 17, characterised in that the control electronics can be operated in a second operating mode in which the syringe piston (160) exclusively executes an inward movement.
